(19) United States
(12) Patent Application Publication
(10) Pub. No.: US 2014/0102284 A1
(43) Pub. Date: Apr. 17, 2014

(54) DEVICE FOR THE RETENTION OF MATCHED SETS OF DRUMSTICKS

(71) Applicants: Alexander RAMIREZ, Garden City, GA (US); Alex RAMIREZ, Brooklyn, NY (US)

(72) Inventors: Alexander RAMIREZ, Garden City, GA (US); Alex RAMIREZ, Brooklyn, NY (US)

(21) Appl. No.: 13/652,729

(22) Filed: Oct. 16, 2012

(51) Int. Cl. G10D 13/02

(52) U.S. Cl. 84/453

(57) ABSTRACT

A retention device for the retention of matched pairs of drumsticks. The device can include at least two retention clamps, each clamp enclosing a channel, and a coupler connecting the at least two retention clamps to each other. Each clamp can have sufficient flexibility so as to allow for the insertion of a drumstick into the channel and so as to frictionally retain a drumstick within the channel. Furthermore, each clamp can include a pair of arms, each arm having a distal end, the distal ends of the arms defining a gap therebetween.

### BACKGROUND

Drumsticks are usually sold in matched sets that have several musically important qualities in common. Generally, each drumstick is weighed and matched with another drumstick of similar weight. Each set of drumsticks is pitch-matched such that both drumsticks resonate at a similar frequency and therefore sound the same. Additionally, both drumsticks in each set of drumsticks are manufactured to the same mechanical specifications. However, drummers often carry more than one pair of drumsticks at a time. Since unmatched drumsticks are visually similar, ensuring that sets of matched sticks remain associated with each other is difficult.

Existing devices intended to solve this problem have several drawbacks. Often, these devices are configured in such a way that they are only appropriate for drumsticks of a particular diameter, rendering them essentially nonfunctional with respect to drumsticks which are only slightly larger or smaller than the diameter required by the device. These devices also usually allow drumsticks to shift or pivot in an undesirable and inconvenient way after they are inserted. In addition, these devices are often oversized and inconveniently shaped, making it difficult to store more than one set of drumsticks in a single bag or carrying case.

### SUMMARY

According to at least one exemplary embodiment, a retention device for the retention of matched pairs of drumsticks is disclosed. The device can include at least two retention clamps, each clamp enclosing a channel, and a coupler connecting the at least two retention clamps to each other. Each clamp can have sufficient flexibility so as to allow for the insertion of a drumstick into the channel and so as to frictionally retain a drumstick within the channel. Furthermore, each clamp can include a pair of arms, each arm having a distal end, the distal ends of the arms defining a gap therebetween.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an oblique view of an exemplary embodiment of retention device.

FIG. 2 shows a front view of an exemplary embodiment of a retention device.

FIG. 3 shows a view of an exemplary embodiment of a retention device that is retaining a matched set of drumsticks.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

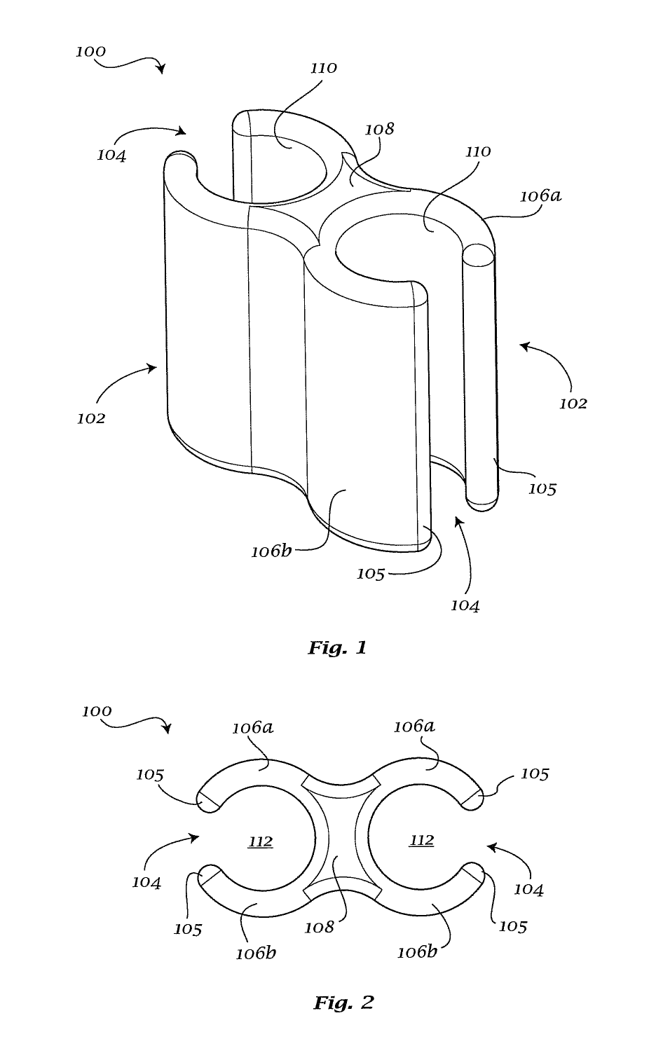

Generally, FIGS. 1-3 refer to a retention device 100 for the retention of one or more matched sets of drumsticks. Retention device 100 can include any desired number of semi-flexible drumstick retention clamps 102. The retention clamps 102 may be connected by a coupler 108. Matched sets of drumsticks may be inserted into retention clamps 102 and thereby retained by the retention device 100 securely and conveniently.

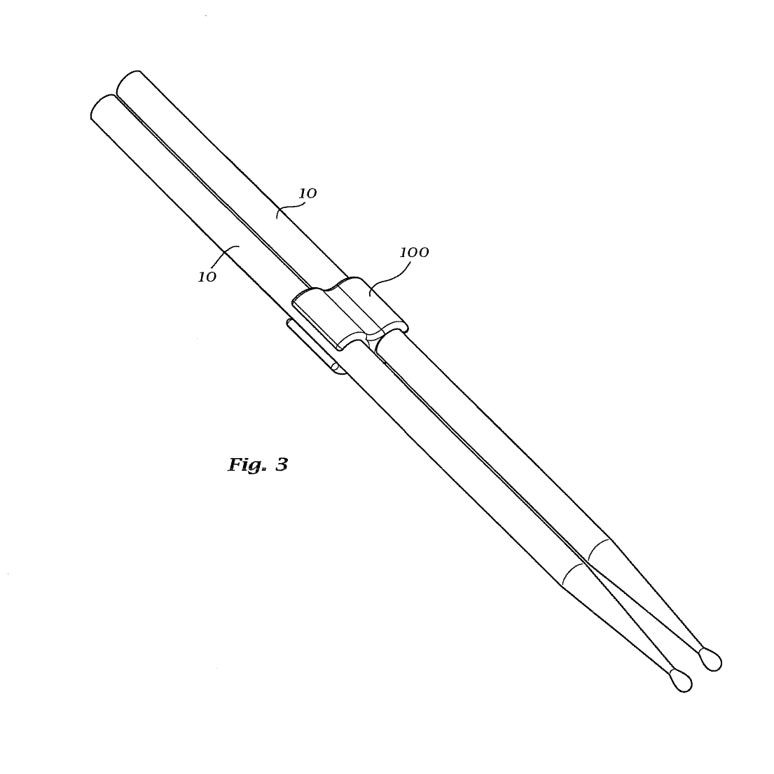

FIGS. 1-2 show an exemplary embodiment of a retention device 100. Retention device 100 can include any desired number of drumstick retention clamps 102. Clamps 102 can be any desired shape. In some exemplary embodiments, each clamp 102 can be a portion of a hollow cylinder, with the cross-section of each clamp 102 being a major arc of the hollow cylinder. Clamp 102 may further have a first arm 106a and a second arm 106b, with a gap 104 defined between the distal ends 105 of first arm 106a and second arm 106b. Arms 106a, 106b may have a substantially arcuate shape. Gap 104 can extend along the length of clamp 102 and substantially parallel to the longitudinal axis thereof.

Arms 106a, 106b can enclose a channel 112. Channel 112 may be substantially cylindrical and may have a radius sized to securely maintain a drumstick within channel 112, for example by friction fit between the drumstick and the inner surfaces 110 of clamps 102. An exemplary radius for channel 112 may be about 0.25 inches. The length of each clamp 102 can be any desired length that enables retention device 100 to function as described herein. An exemplary length for clamps 102 may be approximately 1.25 inches. Furthermore, clamps 102 can be sized to retain any desired drumstick type, shape, size, range of shapes, or range of sizes.

Still referring to FIGS. 1 and 2, in some exemplary embodiments, each clamp 102 may be semi-flexible. In these embodiments, each clamp 102 may be sufficiently flexible so as to allow that a drumstick to be admitted into or removed from channel 112 through gap 104. The insertion and removal of the drumstick may be facilitated by a slight separation of arms 106a, 106b from each other so as to increase the size of gap 104. Additionally, clamps 102 may be adapted to apply sufficient tension to a drumstick disposed within channel 112 so as to frictionally retain the drumstick therein. The tension applied by clamps 102 may be sufficient so as to impede jostling or other movement of the drumstick. Clamps 102 can be constructed of any desired material, for example natural or synthetic plastics, polymers, rubbers, wood, metal, or any other type of material that enables retention device 100 to function as described herein.

Clamps 102 may be connected to each other by a coupler 108, which can join together any desired number of clamps 102. Coupler 108 may be made of any desired material that enables retention device 100 to function as described herein. Coupler 108 may be attached to clamps 102 or may be formed integrally with clamps 102. Furthermore, coupler 108 may have a thickness and/or construction that is sufficient to form a substantially rigid coupling between clamps 102. The rigid coupling can facilitate retaining the drumsticks in a substantially fixed orientation with respect to each other, as well as facilitating impeding any pivoting or other change in orientation of the drumsticks with respect to each other.

FIG. 3 shows an exemplary embodiment of a retention device 100 in which a matched set of drumsticks 10 has been inserted. Drumsticks 10 can be inserted into retention device 100 in any desired manner. In some exemplary embodiments, drumsticks 10 can be inserted longitudinally into channels 112 of clamps 102. In other exemplary embodiments, each drumstick can be placed alongside the gap 104 of a corresponding clamp 102 and then snapped into place, for example by the application of pressure. Retention device 100 can be placed in any location along the length of the drumstick or set of drumsticks, as desired.

The configuration of some exemplary embodiments of retention device 100 can provide benefits when storing multiple sets of drumsticks in one bag or other carrier. In such embodiments, when a set of drumsticks is inserted into and retained within retention device 100, only a small portion of the retention device 100 may extend beyond the profile of the drumsticks themselves. Because of this, more than one set of drumsticks with their associated retention devices 100 can be stored in the same bag, carrier, or other storage device while providing little undesired interference with each other.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A drumstick retention device, comprising:
at least two retention clamps, each clamp enclosing a channel; and
a coupler connecting the at least two retention clamps to each other;
wherein each clamp has sufficient flexibility so as to allow for the insertion of a drumstick into the channel and so as to frictionally retain a drumstick within the channel.

2. The drumstick retention device of claim 1, wherein each clamp includes a pair of arms, each arm having a distal end, the distal ends of the arms defining a gap therebetween.

3. The drumstick retention device of claim 2, wherein each arm has an arcuate shape.

4. The drumstick retention device of claim 1, wherein each clamp is shaped as a portion of a hollow cylinder, the cross-section of which is a major arc of the cylinder.

5. The drumstick retention device of claim 1, wherein the coupler is substantially rigid.

6. The drumstick retention device of claim 1, wherein the coupler maintains the clamps in a fixed orientation with respect to each other.

7. The drumstick retention device of claim 1, wherein the longitudinal axes of the channels of the drumstick retention device are substantially parallel to each other.

8. The drumstick retention device of claim 1, wherein the drumstick retention device is approximately 1.25 inches in length.

9. The drumstick retention device of claim 1, wherein the channel has a radius of approximately 0.25 inches.

10. The drumstick retention device of claim 1, wherein the drumstick retention device is constructed of at least one of natural or synthetic plastic, polymer, rubber, metal, or wood.

11. A drumstick retention device, comprising:
a first pair of arms connected to a second pair of arms by a coupler, each arm of each pair of arms having a distal end;
a channel defined between each pair of arms; and
a gap defined between the distal ends of each pair of arms;
wherein each pair of arms is sufficiently flexible so as to allow for the insertion of a drumstick into the channel through the gap and so as to frictionally retain a drumstick within the channel.

12. The drumstick retention device of claim 11, wherein each arm has an arcuate shape.

13. The drumstick retention device of claim 11, wherein the coupler is substantially rigid.

14. The drumstick retention device of claim 11, wherein the channel has a substantially cylindrical shape.

15. The drumstick retention device of claim 11, wherein the longitudinal axes of the channels of the drumstick retention device are substantially parallel to each other.

16. The drumstick retention device of claim 1, wherein the coupler is substantially rigid.

17. The drumstick retention device of claim 1, wherein the coupler maintains the first pair of arms and the second pair of arms in a fixed orientation with respect to each other.

18. The drumstick retention device of claim 1, wherein the drumstick retention device is approximately 1.25 inches in length.

19. The drumstick retention device of claim 1, wherein the channel has a radius of approximately 0.25 inches.

20. The drumstick retention device of claim 1, wherein the drumstick retention device is constructed of at least one of natural or synthetic plastic, polymer, rubber, metal, or wood.
